(19) United States
(12) Patent Application Publication
(10) Pub. No.: US 2022/0267167 A1
(43) Pub. Date: Aug. 25, 2022

(54) AUTOMATIC SAND FILTER BACKWASH CONTROLLER

(71) Applicant: SAUDI ARABIAN OIL COMPANY, Dhahran (SA)

(72) Inventor: Hussain Saud Al-Sada, Al Jubail (SA)

(73) Assignee: SAUDI ARABIAN OIL COMPANY, Dhahran (SA)

(21) Appl. No.: 17/185,271

(22) Filed: Feb. 25, 2021

(51) Int. Cl. C02F 1/00; B01D 24/00; B01D 24/10; B01D 24/46; B01D 24/48; B01D 35/143

(52) U.S. Cl. CPC C02F 1/008; C02F 1/004; B01D 24/007; B01D 24/105; B01D 24/4636; B01D 24/4861; B01D 24/4884; B01D 35/1435; C02F 2209/40; C02F 2303/16; C02F 2301/08; C02F 2209/03

(57) ABSTRACT

A sand filter controller for monitoring and controlling an operation of a sand filter is provided. The sand filter controller includes a microcontroller that receives information about an operation of the sand filter from sensors installed in the sand filter, electrical relays that control air operated valves (AOVs) of the sand filter based on signals from the microcontroller, a liquid crystal display (LCD) screen connected to the microcontroller and that displays the operation of the sand filter, a position of each of the electrical relays, and a position of each of the AOVs, and a power supply that powers the microcontroller, the electrical relays, and the LCD screen. The sand filter is a single-housing-multi-stage water treatment sand filter.

### BACKGROUND

Water treatment sand filters include multiple mechanical moving parts (e.g., motors, gears, cams, limit switches, etc.) to control air operated valves (AOVs) that allow water or other liquids into and out of the sand filter. These mechanical moving parts are susceptible to repetitive failure and may be costly to maintain and replace. Additionally, these mechanical moving parts (namely, the limit switches) are unable to provide timely and accurate feedback of an operation of the sand filter (e.g., a position of each of the AOVs, a water flow at inlets and outlets of each stage of the sand filter, a failure in the operation of any of the AOVs, a general failure in the sand filter, etc.) to a user. However, users still wish to be able to timely and accurately monitor and control the sand filter's operation at all time.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, one or more embodiments of the present invention relates to a sand filter controller for monitoring and controlling an operation of a sand filter. The sand filter controller comprising: a microcontroller that receives information about an operation of the sand filter from sensors installed in the sand filter; electrical relays that control air operated valves (AOVs) of the sand filter based on signals from the microcontroller; a liquid crystal display (LCD) screen connected to the microcontroller and that displays the operation of the sand filter, a position of each of the electrical relays, and a position of each of the AOVs; and a power supply that powers the microcontroller, the electrical relays, and the LCD screen. The sand filter is a single-housing-multi-stage water treatment sand filter.

In general, one or more embodiments of the present invention relates to a sand filter comprising: air operated valved (AOVs); a plurality of sensors; and a sand filter controller that controls the AOVs and the sensors. The sand filter controller comprises: a microcontroller that receives information about an operation of the sand filter from the sensors; electrical relays that control the AOVs based on signals from the microcontroller; a liquid crystal display (LCD) screen connected to the microcontroller and that displays the operation of the sand filter, a position of each of the electrical relays, and a position of each of the AOVs; and a power supply that powers the microcontroller, the electrical relays, and the LCD screen. The sand filter is a single-housing-multi-stage water treatment sand filter.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows a system in accordance with one or more embodiments of the invention.

FIG. 2 shows a sand filter in accordance with one or more embodiments.

FIG. 3 shows an implementation example in accordance with one or more embodiments of the invention.

FIG. 4 shows an implementation example in accordance with one or more embodiments of the invention.

FIGS. 5A-5C show a flowchart in accordance with one or more embodiments of the invention.

FIG. 6 shows a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments disclosed herein provide a fully electrical sand filter controller (herein referred to simply as “sand filter controller”). More specifically, embodiments disclosed herein relate to an electronic circuit based on a microcontroller programmed via software code to control the operation of the sand filter's AOVs. A sand filter controller of one or more embodiments disclosed herein replaces the above discussed mechanical moving parts in conventional sand filters. For example, gears, cams, limit switches, and motors used to drive the AOVs are replaced with electrical relays that drive electrically actuated AOVs. In one or more embodiments, the sand filter controller replaces all moving and mechanical parts conventionally used to monitor and control an operation of the sand filter. This advantageously improves the reliability of the sand filter controller while also reducing costs related to replacement and maintenance of the mechanical moving parts, which are prone to repetitive failure.

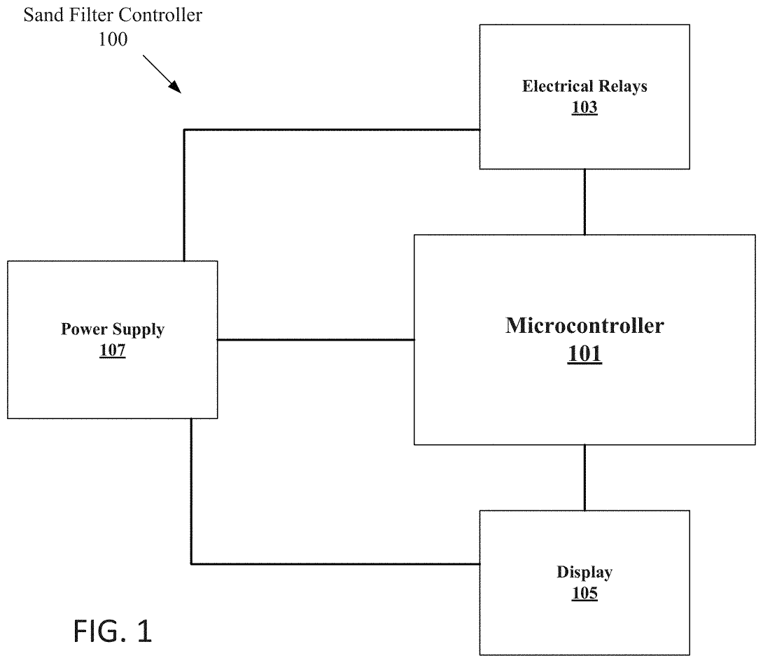

FIG. 1 shows a sand filter controller (100) according to one or more embodiments. As shown in FIG. 1, the sand filter controller (100) has multiple components, including, for example, a microcontroller (101), a set of electrical relays (103), a display (105), and a power supply (107). Each of these components is discussed below.

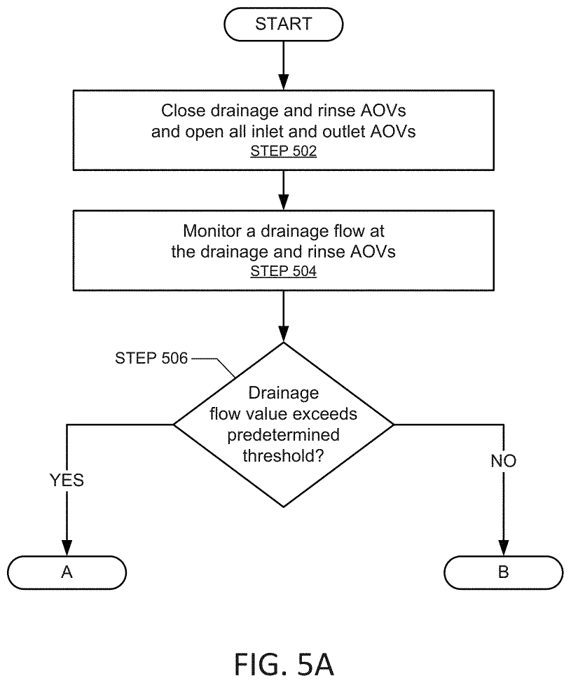

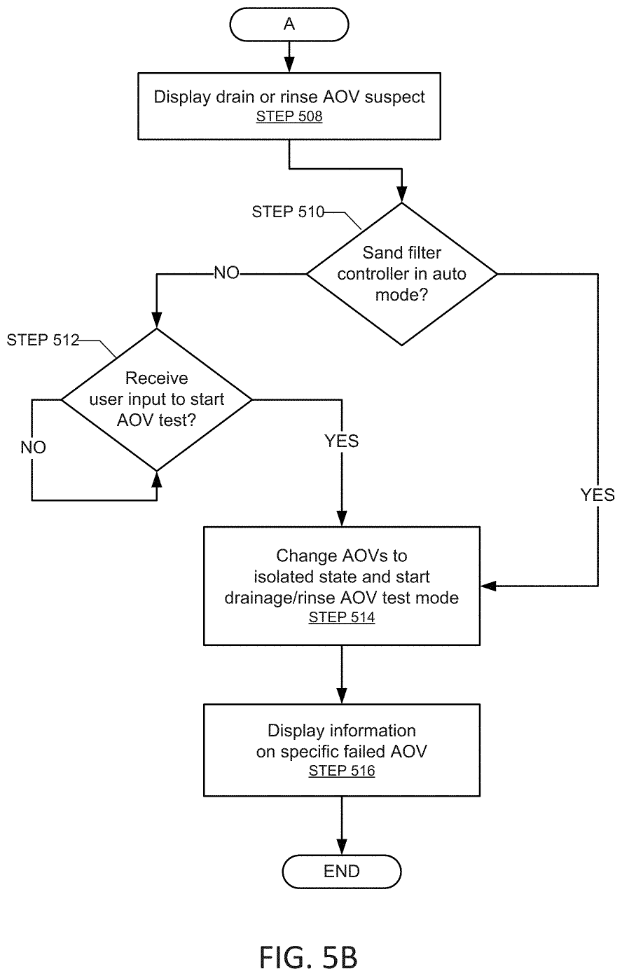

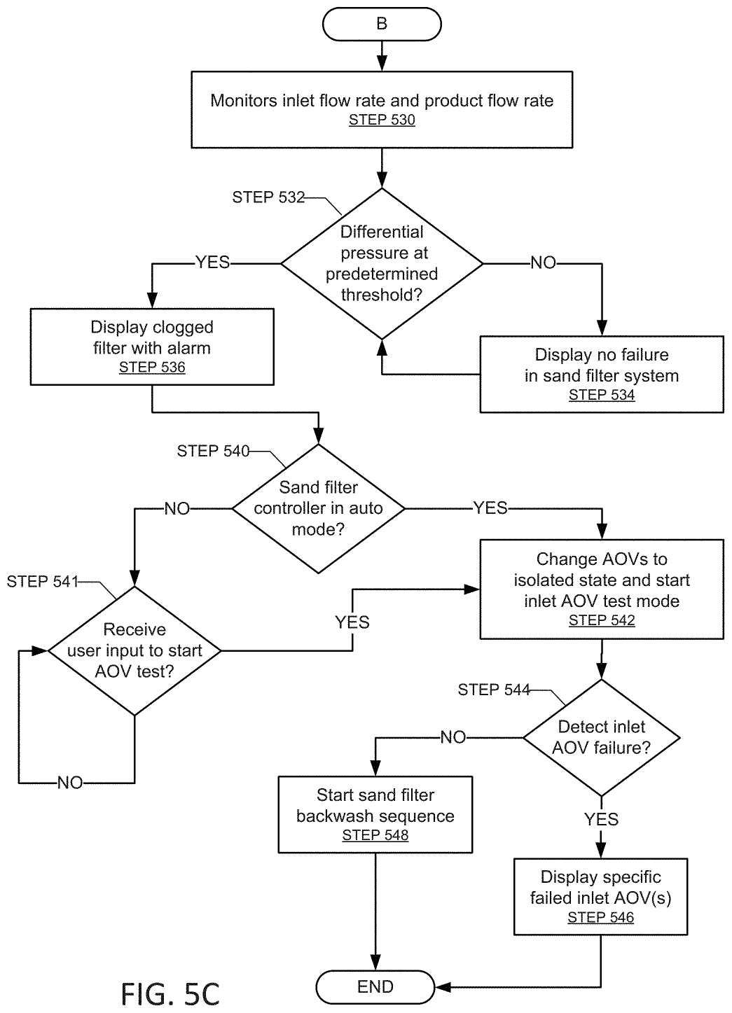

In one or more embodiments, the microcontroller (101) may be a microcontroller board with at least a microprocessor, a memory, and input/output (I/O) peripherals. The I/O peripherals of the microcontroller (101) may include functions such as: analog-to-digital converters, liquid crystal display (LCD) controllers, real-time clock (RTC), universal synchronous/asynchronous receiver transmitter (USART), timers, universal asynchronous receiver transmitter (UART) and universal serial bus (USB) connectivity. The I/O peripheral of the microcontroller (101) may also be connected to sensors and receive information from the sensors. In one or more embodiments, the microcontroller (101) is connected to and controls the electrical relays (103) and display (105). More specifically, in one or more embodiments, the microcontroller (101) may be based on Microchip AT mega 2560 used to receive signals from input devices such as limit switches and pressure switches, and to send output signals and data for the electrical relays (103) and display (105) based on pre-loaded software programs (i.e., software algorithms). Examples of such pre-loaded software programs will be discussed below in reference to FIG. 5. In one or more embodiments, the microcontroller (101) may be programmed in C++ or any other suitable object oriented language.

In one or more embodiments, the set of electrical relays (103) may be a combination of electrically operated switches that form part of a larger programmable logic controller (PLC) module and/or part of a larger digital security control (DSC) system. Each of the electrical relays (103) are connected to the I/O peripherals of the microcontroller (101) and triggered (i.e., the electrically operated switches are turned on and off) through electrical signals transmitted from the microcontroller (101). In one or more embodiments, the set of electrical relays (103) control the operation of the AOVs. For example, each electrical relay among the set of electrical relays (103) is connected to a single AOV. The AOV may be an electrically actuated ball valve with an actuator that controls the movement of the ball valve. When one electrical relay among the set of electrical relays (103) is switched on by the microcontroller (101), the switched on electrical relay passes electricity to the AOV to cause the actuator to move the ball valve between an open and closed position.

Thus, in one or more embodiments, the set of electrical relays (103) may work in combination or individually to open or close the AOVs in response to a failure in the sand filter (e.g., an overflow, a clogged filter, etc.) being detected by the microcontroller (101) through the sensors. The position of each electrical relay (103) may also be displayed on the display (105) to indicate a state of the sand filter (e.g., a normal working state, an alarm state indicating a malfunction, etc.)

In one or more embodiments, the display (105) may be any type of screen (e.g., a liquid crystal display (LCD), a plasma display, touchscreen, cathode ray tube (CRT) monitor, projector, or other display device). The display (105) receives data from the microcontroller (101) to display information related to a condition and status of the sand filter. For example, in one or more embodiments, the information related to the condition and/or status of the sand filter that may be displayed on the screen (105) may include the valves positions, the remaining time for a next step in a backwash process, the filter mode, etc. In one or more embodiments, the display (105) may be an integral part of the microcontroller board having the microcontroller (101). Alternatively, the display (105) may be an external device connected to the I/O peripherals of the microcontroller (101).

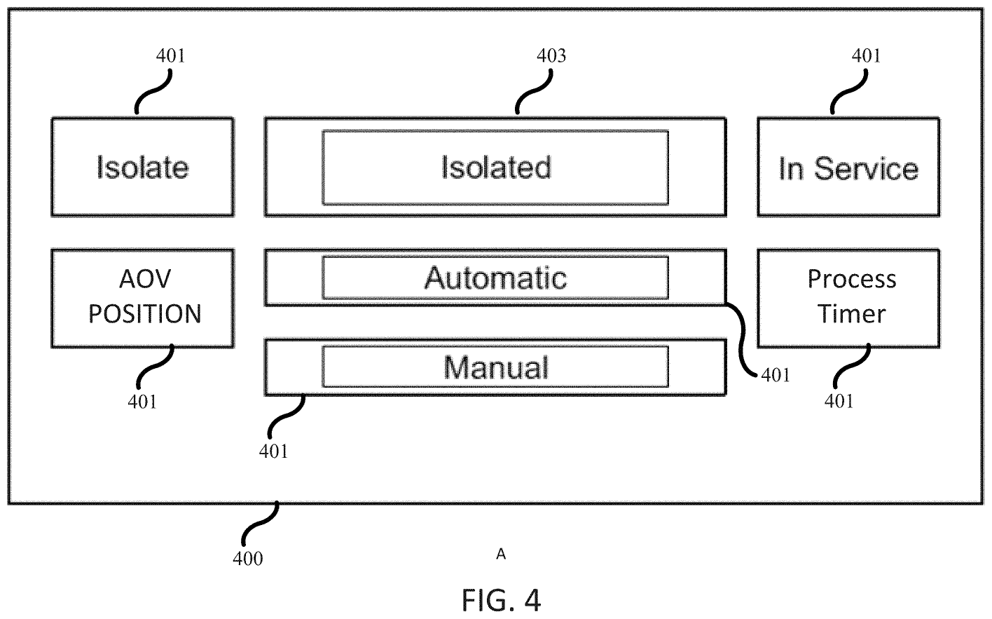

In one or more embodiments, the microcontroller (101) controls the display (105) to display a graphical user interface (GUI) for displaying the data received from the microcontroller (101). An example of the GUI will be discussed in more detail below in reference to FIG. 4.

In one or more embodiments, the power supply (107) may be any type of power source that is able to power the microcontroller (101), the set of electrical relays (103), and the display (105). For example, the power supply (107) is a 110 VAC to 5 VDC power supply.

Although the sand filter controller (100) is shown as having four components (101, 103, 105, 107), in alternate embodiments, the sand filter controller (100) may have more or fewer components. Further, the functionality of each component described above may be split across components. Further still, each component (101, 103, 105, 107) may be utilized multiple times to carry out an iterative operation.

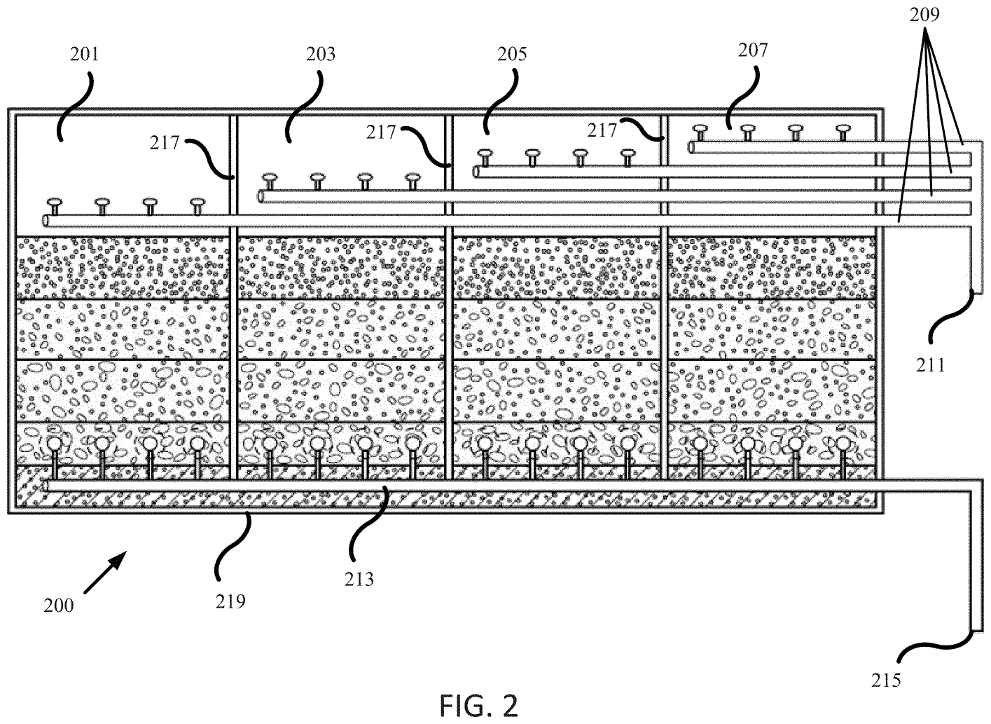

FIG. 2 shows an example sand filter (200) according to one or more embodiments. As shown in FIG. 2, the example sand filter (200) includes four (4) stages (201, 203, 205, 207); however, those skilled in the art will appreciate that the sand filter is not limited to this number of stages and may include any suitable number of stages. As shown in FIG. 2, water is fed into each stage (201, 203, 205, 207) of the sand filter through individual compartment feed pipes (209) connected to a central inlet header (211). The water is filtered through (from top to bottom) a fine sand layer, a fine gravel layer, a medium gravel layer, a coarse gravel layer, and a concrete layer. Additionally, the water filtered through the sand filter (200) is collected by the bottom collection pipe (213) and output through the product header (215). Each of the four stages (201, 203, 205, 207) are separated using compartment separation walls (217) that divide the internal space of the sand filter (200). In one or more embodiments, the compartment separation walls (217) divide the internal space of the sand filter (200) into four equally sized spaces; however; those skilled in the art will appreciate that the internal space of the sand filter (200) can be divided in any suitable manner as long as the sand filter (200) includes at least four stages (201, 203, 205, 207).

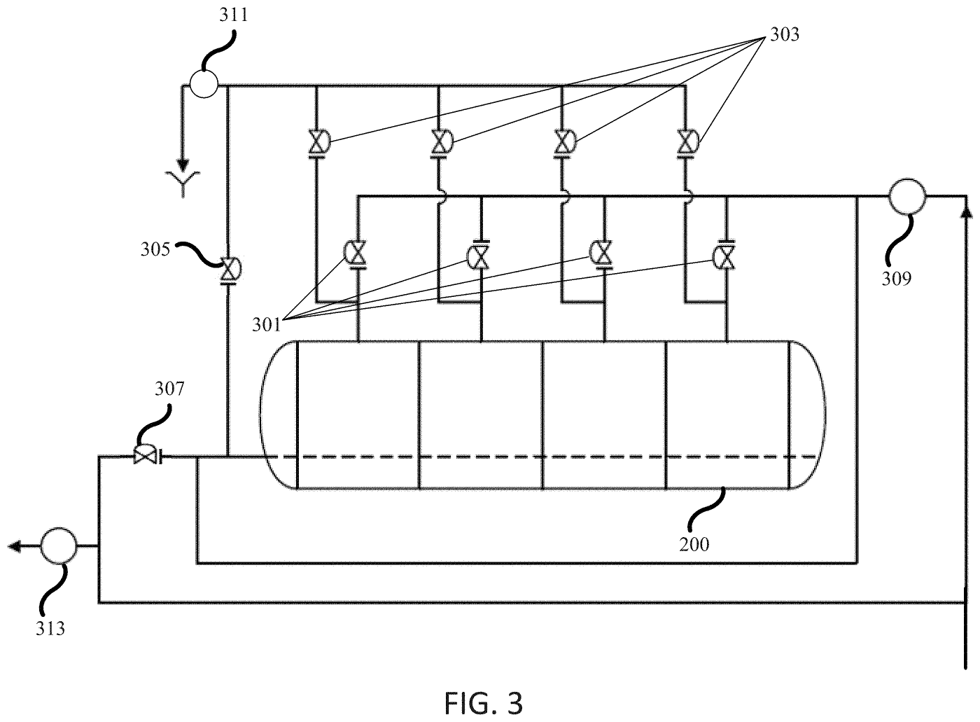

In one or more embodiments, the sand filter (200) shown in FIG. 2 is arranged such that the four stages (also called compartments) (201, 203, 205, 207) are housed in one tank (219), as one unit. Thus, the sand filter (200) is arranged such that the AOVs operate to control output of filtered water through a single outlet (e.g., the product header (215)). The specific placement of each of the AOVs will be described in more detail below in reference to FIG. 3.

FIG. 3 shows a diagram of the sand filter (200) of FIG. 2 including all of the AOVs and sensors (i.e., flow transmitters. As shown in FIG. 3, sand filter (200) includes ten (10) AOVs. These ten AOVs include: four (4) inlet AOVs (301), four (4) drainage AOVs (303), one (1) rinse AOV (305), and one (1) outlet (i.e., product) AOV (307). Each of these AOVs (301, 303, 305, 307) may be a mechanical diaphragm valve coupled to a solenoid valve that receives electrical signals from the electrical relays (103). In one or more embodiments, the mechanical diaphragm valve of the AOVs (301, 303, 305, 307) may be replaced with motor operated valves (MOV) or any other type of control valve that can be controlled through electrical actuation.

Furthermore, each of these AOVs (301, 303, 305, 307) are electrically connected to the sand filter controller (100) and controlled by the microcontroller (101) through the sets of electrical relays (103). In one or more embodiments, the electrical relays (103) control the AOVs (301, 303, 305, 307) in a step-wise manner such that the AOVs (301, 303, 305, 307) are actuated at predetermined intervals from a fully closed position to a fully open position and vice versa. In other words, each AOV (301, 303, 305, 307) includes multiple stages (e.g., a quarter open position, a half-opened position, etc.) between a fully open and a fully closed position, and the electrical relays (130) control each AOV (301, 303, 305, 307) to actuate between these stages in a step-wise (one-stage-at-a-time) manner. This advantageously allows the user to determine the actual position of each AOV (301, 303, 305, 307), which improves upon conventional technologies that are only able to show that an AOV (301, 303, 305, 307) is either fully closed or fully open even if the AOV (301, 303, 305, 307) is in a partially opened or closed state.

In one or more embodiments, the inlet AOVs (301) control a flow of input water into the sand filter (200). The output AOV (307) controls a flow of product water (i.e., filtered water) output from the sand filter (200). The rinse AOV (305) controls an input of water into the sand filter when a backwash sequence for resolving any clogs in the sand filter (200) is initiated. The drainage AOVs (303) control a draining of water from the sand filter (200) and can be opened when water inside the sand filter (200) needs to be emptied (i.e., drained) from the sand filter (200) (e.g., during the backwash sequence, during a cleaning of the sand filter, etc.).

The sand filter (200) further includes an inlet flow transmitter (309), a drain flow transmitter (311), and a product flow transmitter (313) that measure a flow rate and/or water pressure of water entering and exiting from the sand filter (200). These transmitters (309, 311, 313) are connected to the sand filter controller (100) to provide the microcontroller (101) with the flow rate and/or water pressure readings. In one or more embodiments, these transmitters (309, 311, 313) may be sensors (e.g., a flow rate sensor, a pressure sensor, differential pressure sensors, turbine flowmeters, etc.) that are able to directly (e.g., through a wired connection) or indirectly (e.g., through a wireless connection over a transceiver module) transmit their input readings (i.e., read data) to the microcontroller (101). Although FIG. 3 shows the sand filter (300) having only one of each of the inlet flow transmitter (309), the drain flow transmitter (311), and the product flow transmitter (313), those skilled in the art will appreciate that the sand filter may include more than one of each of these transmitters (309, 311, 313) for measuring the sand filter's inlet, outlet, and drainage flow rates.

In one or more embodiments, the microcontroller (101) uses data read from the inlet flow transmitter (309) and the product flow transmitter (313) to determine whether there is a differential pressure in the sand filter (200). This differential pressure indicates that an abnormality exists in a flow or pressure difference between the water entering and exiting the sand filter, which is an indication that a failure (e.g., a clogged compartment, a faulty AOV, etc.) has occurred within the sand filter.

FIG. 4 shows a sample screen (400) displayed on the display (105) in accordance with one or more embodiments. As described above, the display (105) is used to indicate/show the position of the AOVs in each stage of the sand filter and to show the remaining time for the next step in the algorithm described below in FIG. 5. The display (105) may also be used to display or set alarms in case of failure.

As shown in FIG. 4, the screen (400) of the display (105) includes buttons (401) for the user to select whether to operate the sand filter in automatic or manual mode. The display (105) also includes buttons (401) to switch to a different screen showing the position of each AOV and a status of the sand filter (e.g., the current process/step being implemented by the sand filter with a timer indicating a completion time of process/step). The display (105) further includes a section (403) that displays the general status of the sand filter (e.g., isolated or in service) to indicate whether the sand filter is operating normally or whether a failure has occurred. The display (105) also includes buttons (401) for switching between the isolated and in service states. In one or more embodiments, in the isolated state, all inlet AOVs are in the closed position, all drainage AOVs are in the open position, and the outlet AOV is in the closed position.

Furthermore, the section (403) of the display (105) may also display that the sand filter is operating in a fail-safe mode. More specifically, in the event that any part of the sand filter controller (100) fails, the sand filter controller (100) will drive the AOVs to a fail-safe mode to prevents the sand filter from becoming depressurized. This advantageously prevents the pressure within the sand filter from dropping, which allows for a user to resolve the point of failure and restart the operations of the sand filter in a more timely and cost-effective manner. In one or more embodiments, in the fail-safe mode, all drainage AOVs are in the closed position, all inlet AOVs are in the open position, the outlet AOV is in the open position, and the rinse AOV is in the closed position.

FIGS. 5A-5C show a flowchart in accordance with one or more embodiments of the invention. Specifically, the flowchart depicts a process for detecting a failure in the AOVs. One or more of the steps in FIGS. 5A-5C may be performed by the components of the sand filter controller (100), discussed above in reference to FIG. 1. In one or more embodiments of the invention, one or more of the steps shown in FIGS. 5A-5C may be omitted, repeated, and/or performed in a different order than the order shown in FIGS. 5A-5C. Accordingly, the scope of the invention should not be considered limited to the specific arrangement of steps shown in FIGS. 5A-5C.

In STEP 502, the sand filter controller is in a filter mode (i.e., normal operation mode). In the filter mode, the drainage and rinse AOVs are all in the closed position while the inlet and outlet AOVs are all in the open position.

In STEP 504, the microcontroller (101) monitors a value of a drainage flow at a point downstream of the drainage and rinse AOVs.

In STEP 506, the microcontroller (101) determines whether the measured drainage flow value exceed a value of zero (0) or a predetermined system failure threshold value set by a user of the sand filter based on a sand filter operation demand.

In determining that the measured drainage flow value exceeds the value of zero or the predetermined system failure threshold value (i.e., YES in STEP 506), the microcontroller (101) causes the display (105) to display (in STEP 508) an alarm indicating that there is a failure in one or more of the drainage and rinse AOVs. In one or more embodiments, based on the detection, the microcontroller (101) may cause the display (105) to display the specific drainage or rinse AOV that has failed. In determining that the measured drainage flow value does not exceed the value of zero or the predetermined system failure threshold value (i.e., NO in STEP 506), the process proceeds to STEP 530, which will be discussed in more detail later below.

In STEP 510, the microcontroller (101) determines whether the sand filter controller (100) is set at an automatic (i.e., auto) mode. In one or more embodiments, the sand filter controller (100) may be set in an manual mode where the sand filter controller (100) must receive an input from a user before being able to initiate a failure resolution process or in an automatic mode where the sand filter controller (100) may automatically initiate a failure resolution process without any user intervention. In determining that the sand filter controller (100) is not in the automatic mode (i.e., NO in STEP 510), the microcontroller (100) determines in STEP 512 whether a user input to start an AOV test procedure has been received. In determining that the user input to start the AOV test procedure has not been received (i.e., NO in STEP 512), the microcontroller (100) does not start any failure resolution processes and continues to wait for the user input.

Conversely, in determining that the user input to start the AOV test procedure has been received (i.e., YES in STEP 512) or if the microcontroller determines that the sand filter controller (100) is set in the automatic mode (i.e., YES in STEP 510), the microcontroller (101) sets the AOVs into the isolated state where all inlet AOVs are in the closed position, all drainage AOVs are in the open position, and the outlet AOV is in the closed position. Once in the AOVs are in the isolated state, the microcontroller initiates a drainage/rinse AOV test mode in STEP 514.

In one or more embodiments, in the drainage/rinse AOV test mode of STEP 514, the inlet AOVs are first tested to determine if there is an inlet flow (i.e., if an inlet flow is detected) after the inlet AOVs have all been closed. If an inlet flow is detected, then one or more of the inlet AOVs is a failed AOV.

After the inlet AOVs are tested, the drainage and rinse AOVs will be tested by putting the sand filter into standby mode where the drainage, rinse, and outlet AOVs are all closed while all the inlet AOVs are opened. After the sand filter is in the standby mode, the drainage AOVs will be opened (i.e., stroked) one-by-one from a fully closed to fully open position and back to a fully closed position such that only one drainage AOV will be fully opened at a given time, and the drainage flow value is measured when each of the drainage AOV is stroked to the fully opened position. The measured flow values are compared and the drainage AOV with the smallest drainage flow value will be determined as a failed AOV.

For example, assume that a drainage flow value of 50 GPM is detected when all of the drainage and rinse AOVs are closed (i.e., that there is a leak of 50 GPM) and that each drainage AOV is capable of passing a maximum of 200 GPM at the fully opened position. In the case of only a single failed drainage AOV with no failure in the rinse AOV, the drainage AOV producing a drainage flow rate of 200 GPM when fully opened is the failed AOV. In the case of multiple failed drainage AOVs and no failure in the rinse AOV, any drainage AOVs that result in a drainage flow value of less than 250 GPM will be determined as a failed AOV. If all drainage AOVs produce a drainage flow rate of 250 GPM, then the rinse AOV is the failed AOV. If any of the four drainage AOVs produce a drainage flow rate of between 200-250 GPM while the remaining drainage AOVs produces a drainage flow rate of 250 GPM, the failed AOVs are the rinse AOV and any drainage AOV producing a flow rate of between 200-250 GPM.

In STEP 516, after determining the specific failed AOV(s) in the drainage/rinse AOV test mode, the microcontroller (101) causes the display (105) to display all the failed AOVs to the user.

In STEP 530, as a result of the determination in STEP 506 being NO, the microcontroller (101) monitors a flow rate before the inlet AOV (i.e., an inlet flow rate) and a flow rate after the outlet AOV (i.e., a product flow rate). This allows the microcontroller (101) to determine (i.e., calculate) the differential pressure of the sand filter system.

In STEP 532, the controller (532) determines whether the calculated differential pressure has reached a predetermined threshold (e.g., 600 GPM, which is equivalent to approximately 30 psi).

In determining that the differential pressure has not reached the predetermined pressure (i.e., NO in STEP 532), the microcontroller (101) causes the display (105) to display (in STEP 534) that there is no failure (i.e., no failed AOVs and no clogged filters) in the sand filter system. In other words, the display (105) will show that the sand filter is operating in a normal state.

In determining that the differential pressure has reached the predetermined pressure (i.e., YES in STEP 532), the microcontroller (101) causes the display (105) to display (in STEP 536) an alarm indicating that there is a clogged filter. The microcontroller (101) then determines in STEP 540 whether the sand filter controller (100) is set in the auto mode.

In determining that the sand filter controller (100) is not in the automatic mode (i.e., NO in STEP 540), the microcontroller (100) determines in STEP 541 whether a user input to start an AOV test procedure has been received. In determining that the user input to start the AOV test procedure has not been received (i.e., NO in STEP 541), the microcontroller (100) does not start any failure resolution processes and continues to wait for the user input.

Conversely, in determining that the user input to start the AOV test procedure has been received (i.e., YES in STEP 541) or if the microcontroller determines that the sand filter controller (100) is set in the automatic mode (i.e., YES in STEP 540), the microcontroller (101) sets the AOVs into the isolated state where all inlet AOVs are in the closed position, all drainage AOVs are in the open position, and the outlet AOV is in the closed position. Once in the AOVs are in the isolated state, the microcontroller initiates an inlet AOV test mode in STEP 542.

In one or more embodiments, in the inlet AOV test mode of STEP 542, initially the inlet flow rate should be zero when the AOVs of the sand filter are set in the isolated state. The product flow rate should also be zero because the outlet AOV is closed. After reaching a state of equilibrium (i.e., after the sand filter is drained), the drainage flow rate should also be zero.

In the isolated state, if the microcontroller (101) measures a non-zero value for the inlet flow rate, then the failure can be pin-pointed to one of the inlet AOVs. In such a situation, each inlet AOV will be stroked one-by-one (i.e., switched between a fully closed state to a fully opened state and then back to a fully closed state) while the inlet flow is continuously measured. When the inlet AOVs are stroked, only a single inlet AOV will be opened at a single time while the other inlet AOVs remain closed. The inlet flow measured when each inlet AOV is stroked to the fully opened position is compared to determine the specific failed inlet AOV(s).

For example, assume that an inlet flow value of 50 GPM is detected when all of the inlet AOVs are closed (i.e., that there is a leak of 50 GPM) and that each inlet AOV is capable of passing a maximum of 200 GPM at the fully opened position. In the event of only one failed inlet AOV, the failed inlet AOV will produce an inlet flow value of 200 GPM when it is fully opened while all other inlet AOVs will produce a maximum inlet flow value of 250 GPM. In the event of multiple failed inlet AOVs, any inlet AOVs not producing an inlet flow of 250 GPM (i.e., any inlet AOV producing an inlet flow of less than 250 GPM) when fully opened are the failed inlet AOVs.

In STEP 544, based on the results of the inlet AOV test mode of STEP 542, the microcontroller (101) determines whether there are any failed inlet AOVs. In determining that one or more failed inlet AOVs (i.e., YES in STEP 544), the microcontroller (101) causes the display (105) to display the specific failed inlet AOVs to the user in STEP 546.

Conversely, in determining that there are no failed inlet AOVs (i.e., NO in STEP 544), the microcontroller (101) causes the sand filter to perform a backwash sequence in step 548 to clear any clogged filters and causes the display (105) to display that there may be a potential failure at the outlet AOV. The outlet AOV may be determined as a failed AOV when the product flow transmitter detects a flow at the outlet AOV while the outlet AOV is in the closed position.

In one or more embodiments, based on the calculated differential pressure, the microcontroller (101) may start a backwash sequence for all four stages of the sand. In particular, if the differential pressure reaches a predetermined value set by the user of the sand filter, the backwash procedure is initiated for all four stages of the sand filter. This allows the sand filter to have a reliable system rather than separately determining for each stage if a backwash is required. For example, a preparation to enter the isolation state before initiating the backwash process may take 30 minutes to one (1) hour to complete. Therefore, rather than preparing each stage individually and separately backwashing each stage, the backwash process is simultaneously initiated and conducted for all four stages of the sand filter.

In one or more embodiments, during each of the drainage/rinse AOV test mode and inlet AOV test mode, the microcontroller (101) causes the display (105) to display a remaining time of each test mode based on information from the electrical relays (103) about the stroking of the AOVs and from information from the sensors about the measured flow rates. The microcontroller (101) also causes the display (105) to display a remaining time of the backwash sequence when the backwash sequence is initiated in STEP 548.

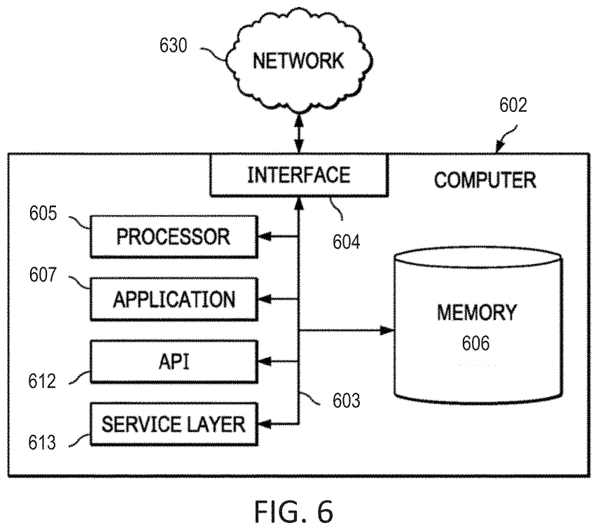

Embodiments of the sand filter controller may be controlled independently by the microcontroller (100) alone. Alternatively, embodiments of the sand filter controller may be controlled by a computer system that sends instructions to the microcontroller (100). FIG. 6 is a block diagram of a computer system (602) used to provide computational functionalities associated with described algorithms, methods, functions, processes, flows, and procedures as described in the instant disclosure, according to an implementation. The illustrated computer (602) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (602) may include a computer that includes an input device, such as a keypad, keyboard, touch screen, or other device that can accept user information, and an output device that conveys information associated with the operation of the computer (602), including digital data, visual, or audio information (or a combination of information), or a GUI.

The computer (602) can serve in a role as a client, network component, a server, a database or other persistency, or any other component (or a combination of roles) of a computer system for performing the subject matter described in the instant disclosure. The illustrated computer (602) is communicably coupled with a network (630). In some implementations, one or more components of the computer (602) may be configured to operate within environments, including cloud-computing-based, local, global, or other environment (or a combination of environments).

At a high level, the computer (602) is an electronic computing device operable to receive, transmit, process, store, or manage data and information associated with the described subject matter. According to some implementations, the computer (602) may also include or be communicably coupled with an application server, e-mail server, web server, caching server, streaming data server, business intelligence (BI) server, or other server (or a combination of servers).

The computer (602) can receive requests over network (630) from a client application (for example, executing on another computer (602)) and responding to the received requests by processing the said requests in an appropriate software application. In addition, requests may also be sent to the computer (602) from internal users (for example, from a command console or by other appropriate access method), external or third-parties, other automated applications, as well as any other appropriate entities, individuals, systems, or computers.

Each of the components of the computer (602) can communicate using a system bus (603). In some implementations, any or all of the components of the computer (602), both hardware or software (or a combination of hardware and software), may interface with each other or the interface (604) (or a combination of both) over the system bus (603) using an application programming interface (API) (612) or a service layer (613) (or a combination of the API (612) and service layer (613). The API (612) may include specifications for routines, data structures, and object classes. The API (612) may be either computer-language independent or dependent and refer to a complete interface, a single function, or even a set of APIs. The service layer (613) provides software services to the computer (602) or other components (whether or not illustrated) that are communicably coupled to the computer (602). The functionality of the computer (602) may be accessible for all service consumers using this service layer. Software services, such as those provided by the service layer (613), provide reusable, defined business functionalities through a defined interface. For example, the interface may be software written in JAVA, C++, or other suitable language providing data in extensible markup language (XML) format or other suitable format. While illustrated as an integrated component of the computer (602), alternative implementations may illustrate the API (612) or the service layer (613) as stand-alone components in relation to other components of the computer (602) or other components (whether or not illustrated) that are communicably coupled to the computer (602). Moreover, any or all parts of the API (612) or the service layer (613) may be implemented as child or sub-modules of another software module, enterprise application, or hardware module without departing from the scope of this disclosure.

The computer (602) includes an interface (604). Although illustrated as a single interface (604) in FIG. 5, two or more interfaces (604) may be used according to particular needs, desires, or particular implementations of the computer (602). The interface (604) is used by the computer (602) for communicating with other systems in a distributed environment that are connected to the network (630). Generally, the interface (604 includes logic encoded in software or hardware (or a combination of software and hardware) and operable to communicate with the network (630). More specifically, the interface (504) may include software supporting one or more communication protocols associated with communications such that the network (630) or interface's hardware is operable to communicate physical signals within and outside of the illustrated computer (602).

The computer (602) includes at least one computer processor (605). Although illustrated as a single computer processor (605) in FIG. 6, two or more processors may be used according to particular needs, desires, or particular implementations of the computer (602). Generally, the computer processor (605) executes instructions and manipulates data to perform the operations of the computer (602) and any algorithms, methods, functions, processes, flows, and procedures as described in the instant disclosure.

The computer (602) also includes a memory (606) that holds data for the computer (602) or other components (or a combination of both) that can be connected to the network (630). For example, memory (606) can be a database storing data consistent with this disclosure. Although illustrated as a single memory (606) in FIG. 6, two or more memories may be used according to particular needs, desires, or particular implementations of the computer (602) and the described functionality. While memory (606) is illustrated as an integral component of the computer (602), in alternative implementations, memory (606) can be external to the computer (602).

The application (607) is an algorithmic software engine providing functionality according to particular needs, desires, or particular implementations of the computer (602), particularly with respect to functionality described in this disclosure. For example, application (607) can serve as one or more components, modules, applications, etc. Further, although illustrated as a single application (607), the application (607) may be implemented as multiple applications (607) on the computer (602). In addition, although illustrated as integral to the computer (602), in alternative implementations, the application (607) can be external to the computer (602).

There may be any number of computers (602) associated with, or external to, a computer system containing computer (602), each computer (602) communicating over network (630). Further, the term “client,” “user,” and other appropriate terminology may be used interchangeably as appropriate without departing from the scope of this disclosure. Moreover, this disclosure contemplates that many users may use one computer (602), or that one user may use multiple computers (602).

In some embodiments, the computer (602) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, and/or function as a service (FaaS).

Embodiments of the present disclosure may provide at least one of the following advantages: improved reliability in determining a point of failure within the sand filter system compared to conventional systems that rely on electro mechanical limit switches for failure detection; improve cost efficiency as a result of replacing mechanical moving parts (e.g., motors, gears, cams, limit switches, etc.) that are easily subjected to wear and tear and that need constant replacement with more electrical parts (e.g., electrical relays); and improved failure detection system utilizing precise measurements that enable accurate and pinpoint location of a point of failure within the sand filter system; etc.

While the disclosure has been described with respect to a limited number of embodiments, those skilled in the art, having benefit of this disclosure, will appreciate that other embodiments can be devised which do not depart from the scope of the disclosure as disclosed herein. Accordingly, the scope of the disclosure should be limited only by the attached claims.

Although the preceding description has been described herein with reference to particular means, materials and embodiments, it is not intended to be limited to the particulars disclosed herein; rather, it extends to all functionally equivalent structures, methods and uses, such as are within the scope of the appended claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed:

1. A sand filter controller for monitoring and controlling an operation of a sand filter, the sand filter controller comprising:
a microcontroller that receives information about an operation of the sand filter from sensors installed in the sand filter;
electrical relays that control air operated valves (AOVs) of the sand filter based on signals from the microcontroller;
a liquid crystal display (LCD) screen connected to the microcontroller and that displays the operation of the sand filter, a position of each of the electrical relays, and a position of each of the AOVs; and
a power supply that powers the microcontroller, the electrical relays, and the LCD screen,
wherein the sand filter is a single-housing-multi-stage water treatment sand filter.

2. The sand filter controller of claim 1, wherein
the AOVs include at least four inlet AOVs, four drainage AOVs, one outlet AOV, and one rinse AOV,
the signals from the microprocessor causes the electrical relays to open and close the AOVs in a step-wise manner, and
the microcontroller causes the LCD screen to display the position of each of the AOVs based on the signals transmitted to the electrical relays.

3. The sand filter controller of claim 1, wherein
the microcontroller receives information related to a differential pressure of the sand filter from sensors,
the sensors include an inlet flow sensor and a product flow sensor,
the microcontroller determines that the sand filter includes the differential pressure using a pressure measured by the inlet flow sensor and a pressure measured by the product flow sensor, and
the differential pressure indicates that sand filter is clogged or that there is one or more faulty AOVs among the AOVs.

4. The sand filter controller of claim 3, wherein the microcontroller causes the LCD to display an alarm that alerts a user of the differential pressure.

5. The sand filter controller of claim 3, wherein
the sensors further include a drain flow sensor that measures a pressure at a drainage AOV from among the AOVs;
the microcontroller determines whether a failure occurred at the any of the AOVs based on a pressure measured by the drain flow sensor.

6. The sand filter controller of claim 5, wherein the microcontroller causes the LCD screen to display an alarm when it is determined that the failure occurred.

7. The sand filter controller of claim 3, wherein
the sand filter internally includes four stages, and
the microcontroller automatically causes all of the four stages to sequentially perform a backwash based on the differential pressure of the sand filter.

8. The sand filter controller of claim 3, wherein
the sand filter internally includes four stages, and
the microcontroller causes only one of the four stages to perform a backwash based on the differential pressure of the sand filter.

9. The sand filter controller of claim 2, wherein
to detect a failure in the AOVs, the microcontroller:
causes the electrical relays to close all of the drainage AOVs and the rinse AOV while opening the outlet AOV and all of the inlet AOVs,
monitors a drainage flow value, at the last least four drainage AOVs and the rinse AOV, transmitted from a drainage flow sensor among the sensors and compares the drainage flow value to a predetermined threshold,
detects the failure in at least one of the drainage AOVs or the rinse AOV based on determining that the drainage flow value exceeds the predetermined threshold or detects the failure in at least one of the inlet AOVs or the output AOV based on determining that the drainage flow value does not exceed the predetermined threshold,
upon detecting the failure, controls the electrical relays to switch all of the AOVs into an isolated state, and
determines which of the AOVs is a failed AOV based on measuring a flow value while sequentially stroking one or more of the AOVs in the isolated state and causes the LCD screen to display information with regard to the failed AOV.

10. The sand filter controller of claim 1, wherein
using the information from the sensors, the microcontroller causes the LCD screen to display a status of the sand filter and a mode of the sand filter, and
the status of the sand filter includes a remaining time for each step in the operation of the sand filter.

11. A sand filter comprising:
air operated valved (AOVs);
a plurality of sensors; and
a sand filter controller that controls the AOVs and the sensors, wherein
the sand filter controller comprises:
a microcontroller that receives information about an operation of the sand filter from the sensors;
electrical relays that control the AOVs based on signals from the microcontroller;
a liquid crystal display (LCD) screen connected to the microcontroller and that displays the operation of the sand filter, a position of each of the electrical relays, and a position of each of the AOVs; and
a power supply that powers the microcontroller, the electrical relays, and the LCD screen,
wherein the sand filter is a single-housing-multi-stage water treatment sand filter.

12. The sand filter of claim 11, wherein
the AOVs include at least four inlet AOVs, four drainage AOVs, one outlet AOV, and one rinse AOV,
the signals from the microprocessor causes the electrical relays to open and close the AOVs in a step-wise manner, and
the microcontroller causes the LCD screen to display the position of each of the AOVs based on the signals transmitted to the electrical relays.

13. The sand filter of claim 11, wherein
the microcontroller receives information related to a differential pressure of the sand filter from sensors,
the sensors include an inlet flow sensor and a product flow sensor,
the microcontroller determines that the sand filter includes the differential pressure using a pressure measured by the inlet flow sensor and a pressure measured by the product flow sensor, and
the differential pressure indicates that sand filter is clogged or that there is one or more faulty AOVs among the AOVs.

14. The sand filter of claim 13, wherein the microcontroller causes the LCD to display an alarm that alerts a user of the differential pressure.

15. The sand filter of claim 13, wherein
the sensors further include a drain flow sensor that measures a pressure at a drainage AOV from among the AOVs;
the microcontroller determines whether a failure occurred at the any of the AOVs based on a pressure measured by the drain flow sensor.

16. The sand filter of claim 15, wherein the microcontroller causes the LCD screen to display an alarm when it is determined that the failure occurred.

17. The sand filter of claim 13, wherein
the sand filter internally includes four stages, and
the microcontroller automatically causes all of the four stages to sequentially perform a backwash based on the differential pressure of the sand filter.

18. The sand filter of claim 13, wherein
the sand filter internally includes four stages, and
the microcontroller causes only one of the four stages to perform a backwash based on the differential pressure of the sand filter.

19. The sand filter of claim 12, wherein
to detect a failure in the AOVs, the microcontroller:
causes the electrical relays to close all of the drainage AOVs and the rinse AOV while opening the outlet AOV and all of the inlet AOVs,
monitors a drainage flow value, at the last least four drainage AOVs and the rinse AOV, transmitted from a drainage flow sensor among the sensors and compares the drainage flow value to a predetermined threshold,
detects the failure in at least one of the drainage AOVs or the rinse AOV based on determining that the drainage flow value exceeds the predetermined threshold or detects the failure in at least one of the inlet AOVs or the output AOV based on determining that the drainage flow value does not exceed the predetermined threshold,
upon detecting the failure, controls the electrical relays to switch all of the AOVs into an isolated state, and
determines which of the AOVs is a failed AOV based on measuring a flow value while sequentially stroking one or more of the AOVs in the isolated state and causes the LCD screen to display information with regard to the failed AOV.

20. The sand filter of claim 11, wherein
using the information from the sensors, the microcontroller causes the LCD screen to display a status of the sand filter and a mode of the sand filter, and
the status of the sand filter includes a remaining time for each step in the operation of the sand filter.
